(19) United States
(12) Patent Application Publication
(10) Pub. No.: US 2025/0203714 A1
(43) Pub. Date: Jun. 19, 2025

(54) METHOD, USER EQUIPMENT AND ACCESS NETWORK NODE

(71) Applicant: NEC Corporation, Minato-ku, Tokyo (JP)

(72) Inventors: Zhe CHEN, Guildford (GB); Neeraj GUPTA, London (GB)

(73) Assignee: NEC Corporation, Minato-ku, Tokyo (JP)

(21) Appl. No.: 18/867,053

(22) PCT Filed: May 16, 2023
(86) PCT No.: PCT/JP2023/018318

§ 371 Date: Nov. 19, 2024

(30) Foreign Application Priority Data
May 23, 2022 (GB) 2207528.7

(51) Int. Cl. H04W 76/40; H04W 84/04

(52) U.S. Cl. CPC H04W 76/40; H04W 84/042

(57) ABSTRACT

A communication system is disclosed in which a Multicast and Broadcast Services (MBS) session is provided in a cell of an access network shared by a plurality of Public Land Mobile Networks (PLMNs). A user equipment (UE) associated with a first PLMN receives information identifying the PLMNs associated with the MBS session to be provided in the cell. The UE receives the MBS session in the cell in a case that the first PLMN is included in the PLMNs associated with the MBS session to be provided in the cell.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to the provision of multimedia broadcast sessions in shared access networks operating according to the so-called ‘5G’ (or ‘Next Generation’) systems or similar.

### BACKGROUND ART

The latest developments of the 3GPP standards are referred to as ‘5G’ or ‘New Radio’ (NR). These terms refer to an evolving communication technology that supports a variety of applications and services. Various details of 5G networks are described in, for example, NPL 1. 3GPP intends to support 5G by way of the so-called 3GPP Next Generation (NextGen) radio access network (RAN) and the 3GPP NextGen core network (NGC).

Under the 3GPP standards, the base station (e.g. an ‘eNB’ in 4G or a ‘gNB’ in 5G) is a node via which communication devices (user equipment or ‘UE’) connect to a core network and communicate to other communication devices or remote servers. For simplicity, the present application will use the term base station to refer to any such base stations.

For simplicity, the present application will use the term mobile device, user device, or UE to refer to any communication device that is able to connect to the core network via one or more base stations.

Communication devices might be, for example, mobile communication devices such as mobile telephones, smartphones, user equipment, personal digital assistants, laptop/tablet computers, web browsers, e-book readers and/or the like.

Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

For simplicity, the present application often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

One of the recent features being developed over the existing 5G framework is referred to as Multicast and Broadcast Services (MBS). This functionality aims to enhance 5G New Radio and 5G Core Network capabilities for a reliable, low latency, resource efficient, and massive deployment of a wide array of multicast and broadcast services. 3GPP is currently specifying the details of MBS for media distribution over mobile broadband networks. MBS (or ‘NR MBS’ in 5G) aims to reuse cellular infrastructure such as the so-called Low Power Low Tower (LPLT) infrastructure. One of the main use cases is the delivery of linear/live media content to smartphones, tablets, vehicles, and other mobile (or stationary) devices. Although MBS is designed to use existing (or already specified) 3GPP infrastructure, it can provide a more efficient delivery of multicast/broadcast traffic than unicast communication using the same infrastructure. Details of architectural enhancements for MBS may be found in the in NPL 2, the contents of which are incorporated herein by reference.

3GPP is working on enhancements to improve the resource efficiency for MBS reception in scenarios when a RAN is shared among multiple Public Land Mobile Networks (PLMNs). RAN sharing does not require to broadcast/multicast the same content via multiple networks, which may be useful, for example, for connected vehicles, TV streaming, amongst others. With RAN sharing, UEs (vehicles) of multiple operators can receive an MBS session from the same PLMN (e.g. a V2X MBS session). In the case of TV streaming, RAN sharing would allow multicasting/broadcasting TV content by one operator.

In LTE, the Multicast and Broadcast Services (MBS) functionality is a PLMN specific service and it is referred to as Multimedia Broadcast/Multicast Services (MBMS). MBS/MBMS is allowed for UEs operating in RRC idle mode (i.e. for UEs without an active UE specific data connection with the network). Each UE interested in MBS monitors the system information broadcast by nearby base stations and determines the resources used for the relevant control channel and data channel (MCCH and MTCH, respectively). The base stations also broadcast the respective identifiers (MBS Session IDs or TMGIs) for each MBS session provided in their cell. The TMGI is the MBS session identifier that uniquely identifies a particular MBS service or session associated with that MBS service. The TMGI has three parts: an MBMS Service ID part; a Mobile Country Code (MCC) part; and a Mobile Network Code (MNC) part. Effectively, the TMGI includes a specific PLMN ID (MCC plus MNC) to prevent UEs from other PLMNs to use the service. If the UE finds its own PLMN ID in the system information for a given cell, then it is allowed to access the cell. However, UEs from another PLMN that can access a cell (of a shared RAN) cannot receive the MBS session if their PLMN ID does not match the TMGI (i.e. the MCC and MNC parts of the TMGI). Whilst in theory point-to-point RAN sharing may be possible for an MBS session (by adding another TMGI corresponding to another PLMN), this approach would be inefficient as it would require duplicating the MBS data for UEs from other PLMNs.

### CITATION LIST

### Non Patent Literature

NPL 1: ‘NGMN 5G White Paper’ V1.0, Next Generation Mobile Networks (NGMN) Alliance, <https://www.ngmn.org/5g-white-paper.html>
NPL 2:3GPP TS 23.247 V17.2.0
NPL 3:3GPP TS 38.413 V17.0.0
NPL 4:3GPP TS 24.116 V17.0.0
NPL 5:3GPP TS 23.246 V17.0.0
NPL 6:3GPP TS 23.003 V17.5.0
NPL 7:3GPP TS 24.501 V17.6.1
NPL 8:3GPP TS 38.300 V16.7.0
NPL 9:3GPP TS 37.340 V16.7.0

### SUMMARY OF INVENTION

### Technical Problem

The inventors have realised that there are a number of issues with the current approach to provision of MBS functionality via a RAN (base station) shared by multiple PLMNs.

For example, MBS is allowed for UEs operating in RRC idle mode (i.e. for UEs without an active UE specific data connection with the network). Each UE interested in MBS monitors the system information broadcast by the base stations and determines the resources used for the relevant control channel and data channel (MCCH and MTCH, respectively). If the UE finds its own PLMN ID in the system information for a given cell, then it is allowed to access the cell. The base stations also broadcast the respective identifiers (MBS Session IDs or TMGIs) for each MBS session provided in their cell. However, MBS was designed to be a PLMN specific service and the TMGI of an MBS session contains only one PLMN ID which prevents UEs from other networks from using the service. This may result in a scenario that even though UEs from another PLMN can access the cell, they cannot receive the MBS session if their PLMN ID does not match the TMGI. Thus, it is not clear how to allow UEs from other PLMNs that they are allowed to receive MBS in a shared network.

Currently, base stations do not have information regarding which MBS services and which PLMNs are supported by their neighbours and they do not have any mechanism for providing the necessary configuration to UEs for receiving an MBS session via a shared base station (e.g. a neighbour base station). This may cause issues with mobility as the UEs may not be able to select the correct cell for receiving MBS or they may need to use point-to-point (unicast) bearers.

Accordingly, the present disclosure seeks to provide methods and associated apparatus that address or at least alleviate (at least some of) the above-described issues.

### Solution to Problem

In one aspect, the disclosure provides a method performed by a user equipment (UE) associated with a first Public Land Mobile Network (PLMN), the method comprising: receiving information identifying a plurality of PLMNs which correspond to a shared radio access network and which are associated with a Multicast and Broadcast Services (MBS) session to be provided in a cell operated by the shared radio access network; and receiving the MBS session in the cell based on the information.

In one aspect, the disclosure provides a method performed by a user equipment (UE) associated with a first Public Land Mobile Network (PLMN), the method comprising receiving, from the first PLMN, a Multicast and Broadcast Services (MBS) container including configuration information for receiving an MBS session via a second PLMN.

In one aspect, the disclosure provides a method performed by an access network node for a radio access network shared among a plurality of Public Land Mobile Networks (PLMNs), the method comprising: transmitting, in a cell of the shared radio access network, information identifying the plurality of PLMNs associated with a Multicast and Broadcast Services (MBS) session to be provided in the cell; and transmitting, in the cell, the MBS session based on the information.

In one aspect, the disclosure provides a method performed by an access network node for a radio access network shared among a plurality of Public Land Mobile Networks (PLMNs), for providing a Multicast and Broadcast Services (MBS) session in a cell, the method comprising: receiving, from a core network function of a first PLMN of the plurality of the PLMNs, information identifying at least one PLMNs among the plurality of PLMNs, for which the MBS session is allowed in the cell.

In one aspect, the disclosure provides a method performed by an access network node for providing Multicast and Broadcast Services (MBS), the method comprising: receiving, from another access network node which operates a cell of a radio access network shared among a plurality of Public Land Mobile Networks (PLMNs), first information identifying at least one MBS session supported in the cell and second information identifying, for each particular MBS session of the at least one MBS session, at least one PLMN which supports the particular MBS session.

In one aspect, the disclosure provides a method performed by an access network node operating a cell shared among a plurality of Public Land Mobile Networks (PLMNs), the method comprising: transmitting, to another access network node operating a neighbour cell, first information identifying at least one Multicast and Broadcast Services (MBS) session supported by the access network node and second information identifying, for each particular MBS session, at least one PLMN which supports the particular MBS session.

In one aspect, the disclosure provides a method performed by an access network node for a radio access network shared among a plurality of Public Land Mobile Networks (PLMNs), the method comprising: transmitting, to a core network function, information identifying the plurality of PLMNs; and receiving, from the core network function, an MBS container including configuration information for providing a Multicast and Broadcast Services (MBS) session for at least one PLMN among the plurality of PLMNs and information identifying the at least one PLMN for which the MBS session is allowed via the shared access network.

In one aspect, the disclosure provides a method performed by an access network node associated with a first Public Land Mobile Network (PLMN), the method comprising: transmitting, to a user equipment (UE), information identifying a second PLMN as a PLMN that provides a Multicast and Broadcast Services (MBS) session and information identifying a frequency for the MBS session.

In one aspect, the disclosure provides a method performed by a core network function, the method comprising: receiving, from an access network node for a radio access network shared among a plurality of Public Land Mobile Networks (PLMNs), information identifying the plurality of PLMNs; and transmitting, to the access network node, an MBS container including configuration information for providing a Multicast and broadcast Services (MBS) session for at least one PLMNs among the plurality of PLMNs and information identifying the at least one PLMN for which the MBS session is allowed via the shared access network.

In one aspect, the disclosure provides a method performed by core network function associated with a first Public Land Mobile Network (PLMN), the method comprising: receiving, from a second PLMN, a Multicast and Broadcast Services (MBS) container for the second PLMN, the MBS container including configuration information for providing an MBS session in the second PLMN.

In one aspect, the disclosure provides a user equipment (UE) associated with a first Public Land Mobile Network (PLMN), the UE comprising: means (for example a memory, a controller, and a transceiver) for receiving information identifying a plurality of PLMNs which correspond to a shared radio access network and which are associated with a Multicast and Broadcast Services (MBS) session to be provided in a cell operated by the shared radio access network; and means for receiving the MBS session in the cell based on the information.

In one aspect, the disclosure provides a user equipment (UE) associated with a first Public Land Mobile Network (PLMN), the UE comprising: means (for example a memory, a controller, and a transceiver) for receiving, from the first PLMN, a Multicast and Broadcast Services (MBS) container including configuration information for receiving an MBS session via a second PLMN.

In one aspect, the disclosure provides an access network node for a radio access network shared among a plurality of Public Land Mobile Networks (PLMNs), the access network node comprising: means (for example a memory, a controller, and a transceiver) for transmitting, in a cell of the shared radio access network, information identifying the plurality of PLMNs associated with a Multicast and Broadcast Services (MBS) session to be provided in the cell; and means for transmitting, in the cell, the MBS session based on the information.

In one aspect, the disclosure provides an access network node for a radio access network shared among a plurality of Public Land Mobile Networks (PLMNs), for providing a Multicast and Broadcast Services (MBS) session in a cell, the access network node comprising: means (for example a memory, a controller, and a transceiver) for receiving, from a core network function of a first PLMN of the plurality of the PLMNs, information identifying at least one PLMNs among the plurality of PLMNs, for which the MBS session is allowed in the cell.

In one aspect, the disclosure provides an access network node for providing Multicast and Broadcast Services (MBS), the access network node comprising: means (for example a memory, a controller, and a transceiver) for receiving, from another access network node which operates a cell of a radio access network shared among a plurality of Public Land Mobile Networks (PLMNs), first information identifying at least one MBS session supported in the cell and second information identifying, for each particular MBS session of the at least one MBS session, at least one PLMN which supports the particular MBS session.

In one aspect, the disclosure provides an access network node operating a cell shared among a plurality of Public Land Mobile Networks (PLMNs), the access network node comprising: means (for example a memory, a controller, and a transceiver) for transmitting, to another access network node operating a neighbour cell, first information identifying at least one Multicast and Broadcast Services (MBS) session supported by the access network node and second information identifying, for each particular MBS session, at least one PLMN which supports the particular MBS session.

In one aspect, the disclosure provides an access network node for a radio access network shared among a plurality of Public Land Mobile Networks (PLMNs), the access network node comprising: means (for example a memory, a controller, and a transceiver) for transmitting, to a core network function, information identifying the plurality of PLMNs; and means for receiving, from the core network function, an MBS container including configuration information for providing a Multicast and Broadcast Services (MBS) session for at least one PLMN among the plurality of PLMNs and information identifying the at least one PLMN for which the MBS session is allowed via the shared access network.

In one aspect, the disclosure provides an access network node associated with a first Public Land Mobile Network (PLMN), the access network node comprising: means (for example a memory, a controller, and a transceiver) for transmitting, to a user equipment (UE), information identifying a second PLMN as a PLMN that provides a Multicast and Broadcast Services (MBS) session and information identifying a frequency for the MBS session.

In one aspect, the disclosure provides a core network function comprising: means (for example a memory, a controller, and a transceiver) for receiving, from an access network node for a radio access network shared among a plurality of Public Land Mobile Networks (PLMNs), information identifying the plurality of PLMNs; and means for transmitting, to the access network node, an MBS container including configuration information for providing a Multicast and broadcast Services (MBS) session for at least one PLMNs among the plurality of PLMNs and information identifying the at least one PLMN for which the MBS session is allowed via the shared access network.

In one aspect, the disclosure provides a core network function associated with a first Public Land Mobile Network (PLMN), the core network function comprising: means (for example a memory, a controller, and a transceiver) for receiving, from a second PLMN, a Multicast and Broadcast Services (MBS) container for the second PLMN, the MBS container including configuration information for providing an MBS session in the second PLMN.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the disclosure will now be described, by way of example, with reference to the accompanying drawings in which:

FIG. 1 illustrates schematically a mobile (cellular or wireless) telecommunication system to which example embodiments of the disclosure may be applied;

FIG. 2 illustrates schematically a mobile (cellular or wireless) telecommunication system to which example embodiments of the disclosure may be applied;

FIG. 3 is a schematic block diagram of a mobile device forming part of the system shown in FIGS. 1 and 2;

FIG. 4 is schematic block diagram of an access network node (e.g. base station) forming part of the system shown in FIGS. 1 and 2;

FIG. 5 is schematic block diagram of an access network node (e.g. base station) forming part of the system shown in FIGS. 1 and 2;

FIG. 6 is a schematic block diagram of a core network node forming part of the system shown in FIGS. 1 and 2;

FIG. 7 illustrates schematically an exemplary way in which the present disclosure may be implemented in the system shown in FIGS. 1 and 2;

FIG. 8 illustrates schematically an exemplary way in which the present disclosure may be implemented in the system shown in FIGS. 1 and 2;

FIG. 9 illustrates schematically an exemplary way in which the present disclosure may be implemented in the system shown in FIGS. 1 and 2;

FIG. 10 illustrates schematically an exemplary way in which the present disclosure may be implemented in the system shown in FIGS. 1 and 2;

FIG. 11 illustrates schematically an exemplary way in which the present disclosure may be implemented in the system shown in FIGS. 1 and 2;

FIG. 12 illustrates schematically an exemplary way in which the present disclosure may be implemented in the system shown in FIGS. 1 and 2;

FIG. 13 illustrates schematically an exemplary way in which the present disclosure may be implemented in the system shown in FIGS. 1 and 2; and

FIG. 14 illustrates schematically an exemplary way in which the present disclosure may be implemented in the system shown in FIGS. 1 and 2.

### DESCRIPTION OF EMBODIMENTS

### Overview

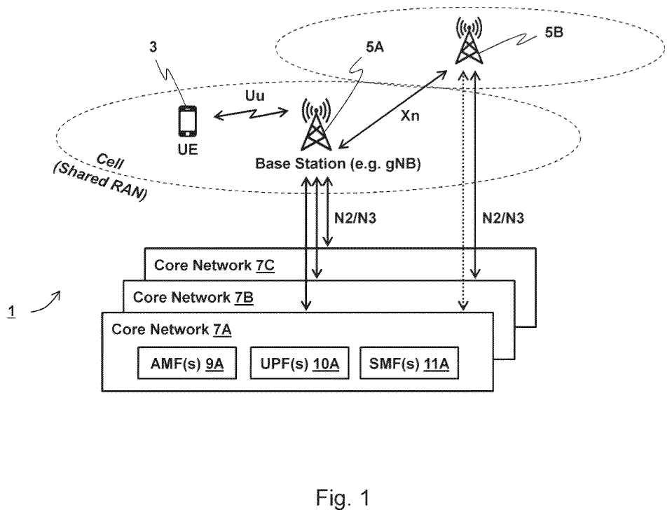

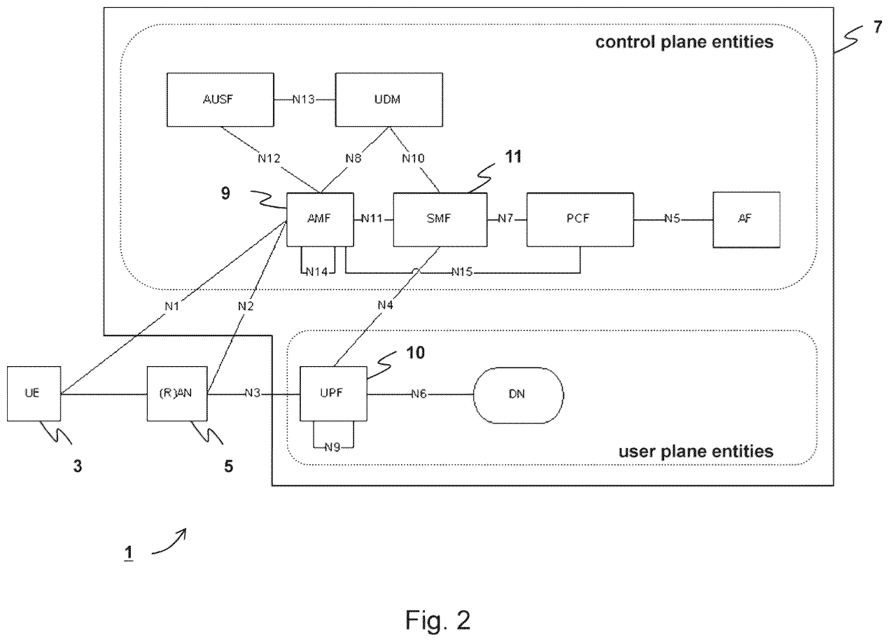

FIGS. 1 and 2 illustrate schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and associated core networks 7 using an appropriate 3GPP radio access technology (RAT), for example, an Evolved Universal Terrestrial Radio Access (E-UTRA) and/or 5G RAT. It will be appreciated that a number of base stations 5 form a (radio) access network or (R)AN. As those skilled in the art will appreciate, whilst one mobile device 3 and two base stations 5A and 5B are shown in FIG. 1 for illustration purposes, the system, when implemented, will typically include other base stations/(R)AN nodes and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

A core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification, and release. In the example shown in FIG. 1, each core network 7A to 7C includes one or more AMF(s) 9, one or more UPF(s) 10, and one or more SMF(s) 11. It will be appreciated that the nodes or functions may have different names in different systems.

Further details of the core network 7 are shown in FIG. 2 which also shows the interfaces between respective network nodes. As can be seen, the core network 7 may typically include an Authentication Server Function (AUSF), a Unified Data Management (UDM) entity, a Policy Control Function (PCF), an Application Function (AF), amongst others. The core network 7 is coupled (via the UPF 10) to a Data Network (DN), such as the Internet or a similar Internet Protocol (IP) based network. The core network 7 may also be coupled to an Operations and Maintenance (OAM) function (not shown).

Various network operators deploy their base stations 5 and an associated core network 7 to provide services in a given area (e.g. a country). Each network may also be referred to as a Public Land Mobile Network (PLMN) and it is uniquely identified by its PLMN identifier (PLMN ID). The PLMN ID consists of a Mobile Country Code (MCC) and a Mobile Network Code (MNC). In the example shown in FIG. 1, each core network 7A to 7C has an associated PLMN ID and each core network 7A to 7C is connected to one or more access network. Each subscriber (i.e. UE 3) belongs to one of the PLMNs and uses services of the associated core network 7 and access network (i.e. base stations 5).

In the example shown in FIG. 1, the first base station 5A belongs to an access network that is shared among three network operators or PLMNs. Thus, in addition to its own operator's core network 7A, the shared base station 5A (or shared RAN) is also connected to the core networks 7B and 7C of the other PLMNs that share the base station 5A. The second base station 5B is currently not shared, thus it is connected to its own core network 7B only. The second PLMN provides services via its own RAN (which includes base station 5B) and via the shared RAN. In this example, the operator of the third core network 7C does not have its own RAN in the given area (although it may have some base stations deployed elsewhere). The third operator/PLMN can provide some services via the shared RAN/shared base station 5A.

Multicast and Broadcast Services (MBS) functionality may be provided to the UEs 3 via their serving base station 5 and associated core network nodes such as the UPF 10 and the SMF 11. The UPF 10 may be an MBS specific UPF in which case it may be referred to as the MB-UPF (e.g. dedicated to the provision of MBS functionality). Similarly, the SMF 11 may be an MBS specific SMF in which case it may be referred to as the MB-SMF. However, it will be appreciated that any suitable UPF 10/SMF 11 may be used for MBS.

In this system 1, MBS functionality may also be provided to UEs 3 via the shared base station 5A (shared RAN), to subscribers of each PLMN that shares the base station 5A (and that are allowed to use MBS in the shared RAN). By using a shared RAN/base station 5A it is possible to avoid or minimise redundant MBS transmissions via multiple networks thereby improving the overall efficiency of multicast/broadcast traffic delivery.

The UE 3 shown in FIG. 1 belongs to the second PLMN that operates the second core network 7B and the second base station 5B. However, as can be seen, the UE 3 is currently located in a cell of the shared base station 5A.

As explained above, MBS is a PLMN specific service. MBS is allowed for UEs 3 operating in RRC idle mode (i.e. for UEs without an active UE specific data connection with the network). Each UE 3 interested in MBS monitors the system information broadcast by the base stations 5 and determines the resources used for the relevant control channel and data channel (MCCH and MTCH, respectively). The base stations 5 also broadcast the respective identifiers (MBS Session IDs or TMGIs) for each MBS session provided in their cell.

If the UE 3 finds its own PLMN ID in the system information for a given cell, then it is allowed to access the cell. However, in existing systems, the TMGI that identifies a particular MBS session is limited to one PLMN ID. Thus, even though UEs 3 from another PLMN can access the cell, they cannot receive the MBS session if their PLMN ID does not match the TMGI (i.e. the PLMN ID portion of the TMGI). Whilst in theory point-to-point RAN sharing may be possible for an MBS session (by adding another TMGI corresponding to another PLMN), this approach would be inefficient as it would require duplicating the MBS data for UEs from other PLMNs.

In order to allow the UE 3 to receive data for an MBS session via the shared based station 5A, the nodes of this system are configured as follows. It will be appreciated that the following methods may be particularly useful for providing an MBS session for all UEs of different PLMNs, using point-to-multipoint transmission (a point-to-multipoint bearer via the shared based station 5A).

In this system, the shared base station 5A transmits to the UEs 3 in its cell information identifying the PLMNs associated with a particular MBS session provided in the cell. A UE 3 is allowed to receive the MBS session in a case that the UE's PLMN is one of the PLMNs indicated by the base station 5A (assuming that the UE 3 is allowed to access the cell based on the list of supported PLMNs in SIB1, as described above).

In order to identify the PLMNs associated with a particular MBS session, the following options may be used.

In a first option, the base station 5A transmits a mapping table to the UEs 3, the mapping table indicating the identifier (TMGI) associated with the MBS session and the respective PLMNs associated with the MBS session. The mapping table may be transmitted via the MBS Control Channel (MCCH) or via an application layer procedure.

In a second option, network sharing for an MBS session may be indicated using a special MBS session identifier (TMGI) associated with (reserved for) network sharing. This special TMGI may include a PLMN ID value (a combination of an MCC value and an MNC value, or at least a specific MNC value) that indicates network sharing.

In a third option, a special TMGI structure may be used to indicate more than one specific PLMNs. For example, the TMGI may be extended by adding further MCC and MNC values for each additional PLMN. The PLMN IDs may be separated by an appropriate field (e.g. one bit) indicating whether there are any additional PLMNs in the TMGI.

In this system, MBS services are provided by the operator of the shared base station 5A. However, different MBS services may be shared by different PLMNs (e.g. one MBS session may be shared with PLMN B and another MBS session may be shared PLMN C).

Thus, the shared base station 5A obtains, from the AMF 9A (which belongs to the MBS service provider's core network 7A) information identifying the PLMNs allowed for each MBS service (e.g. an ‘allowed PLMN list’ information element and/or the like). This information may be obtained as part of a procedure for establishing an MBS session.

Once the base station 5A knows which PLMNs are allowed for a particular MBS session, the base station 5A transmits to the UEs 3 information identifying the PLMNs associated with that MBS session (e.g. a mapping table or a PLMN ID/TMGI indicating network sharing).

Neighbouring base stations 5 are also configured to exchange information indicating which PLMNs are supported for each MBS session (e.g. a supported PLMN list per MBS session). This information may be exchanged using the base station to base station (e.g. Xn) interface between the base stations 5. This procedure may be particularly useful for facilitating UE mobility between different cells by taking into account the PLMNs supported in each cell (e.g. to help idle mode UEs select an appropriate cell for receiving an MBS session). In case of a handover of a UE 3, the source base station 5 knows which neighbour cell supports a particular MBS service for the UE's PLMN, and it can decide about the handover (select a target cell) accordingly.

Each UE 3 needs to obtain appropriate MBS configuration for receiving data for an MBS session (using a unicast or multicast bearer). This MBS configuration is referred to as an ‘MBS container’ using the currently adopted 3GPP terminology.

If the PLMN ID of the UE's home PLMN is included in the system information for a shared network, then the UE 3 can perform initial access to that network (which may be referred to as the serving PLMN). However, the UE 3 may not have access to any other services in the serving PLMN than MBS. Beneficially, the UE 3 can obtain from its home PLMN the necessary MBS configuration for receiving an MBS session provided by another PLMN. In this system, the MBS container is sent to the UE 3 by the home PLMN (the AMF 9/SMF 11) using the so-called PDU Session Modification Command message.

### User Equipment (UE)

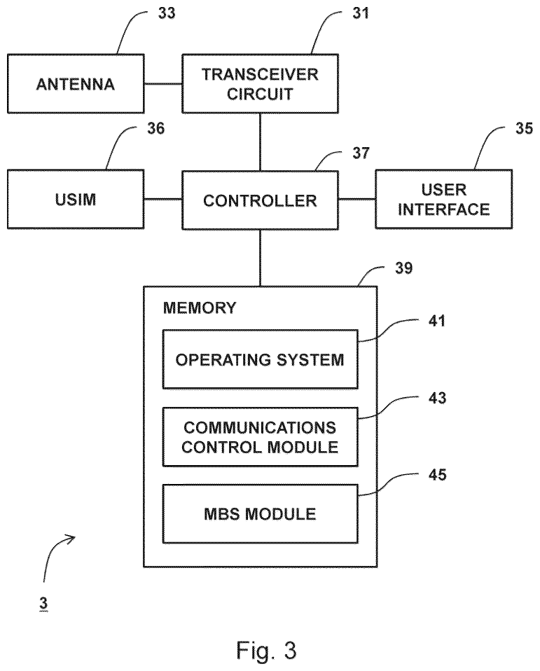

FIG. 3 is a block diagram illustrating the main components of the mobile device (UE) 3 shown in FIGS. 1 and 2. As shown, the UE 3 includes a transceiver circuit 31 which is operable to transmit signals to and to receive signals from the connected node(s) via one or more antenna 33. Although not necessarily shown in FIG. 3, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43 and an MBS module 45.

The communications control module 43 is responsible for handling (generating/sending/receiving) signalling messages and uplink/downlink data packets between the UE 3 and other nodes, including (R)AN nodes 5 and core network nodes. The signalling may comprise RRC signalling (to/from the (R)AN nodes 5) and/or NG-C/NG-U signalling (to/from the core network 7).

The MBS module 45 is responsible for handling signalling relating to multimedia broadcast services. The signalling may include signalling for configuring the UE 3 for receiving an MBS session via a shared RAN/shared base station.

### Access Network Node (Base Station)

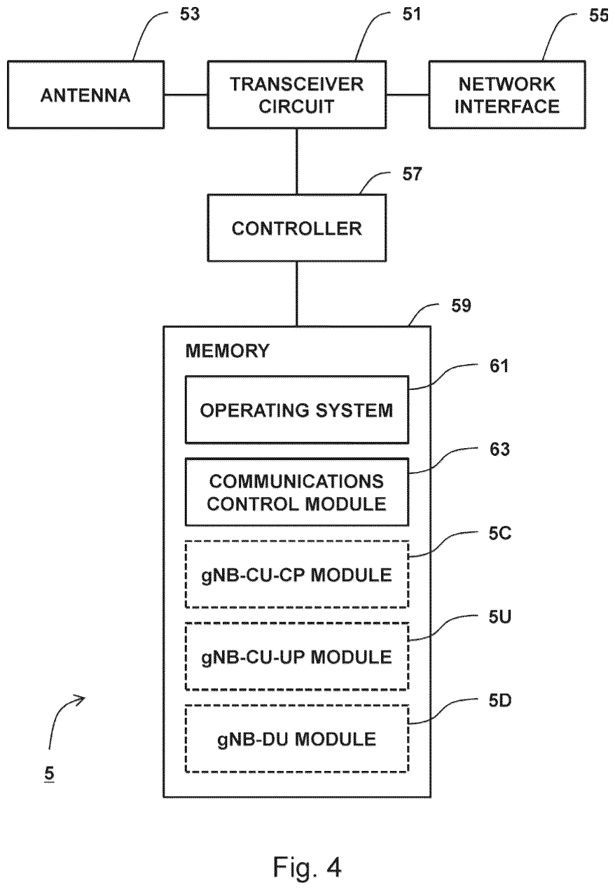

FIG. 4 is a block diagram illustrating the main components of a base station 5 (or a similar access network node) shown in FIG. 1. As shown, the base station 5 has a transceiver circuit 51 for transmitting signals to and for receiving signals from user equipment (such as the mobile device 3) via one or more antenna 53, a network interface 55 for transmitting signals to and for receiving signals from the core network 7 and neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63. Although not shown in FIG. 4, the network interface 55 will also typically include a base station to base station interface portion (e.g. Xn and/or the like), and a core network interface portion (e.g. NG-C/NG-U/N2/N3).

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. Non-Access Stratum, Radio Resource Control, system information, paging, and/or the like). The signalling may include signalling for configuring the UE 3 for receiving an MBS session via a shared RAN/shared base station, and signalling for configuring other nodes for providing the MBS session via the shared RAN/shared base station. It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

In the 5G architecture, the base station (gNB or en-gNB) internal structure may be split into two parts known as the Central Unit (CU) and the Distributed Unit (DU), connected by an F1 interface. In this ‘split’ architecture, typically ‘higher’, CU layers (for example, but not necessarily or exclusively), PDCP) and the typically ‘lower’, DU layers (for example, but not necessarily or exclusively, RLC/MAC/PHY) may be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

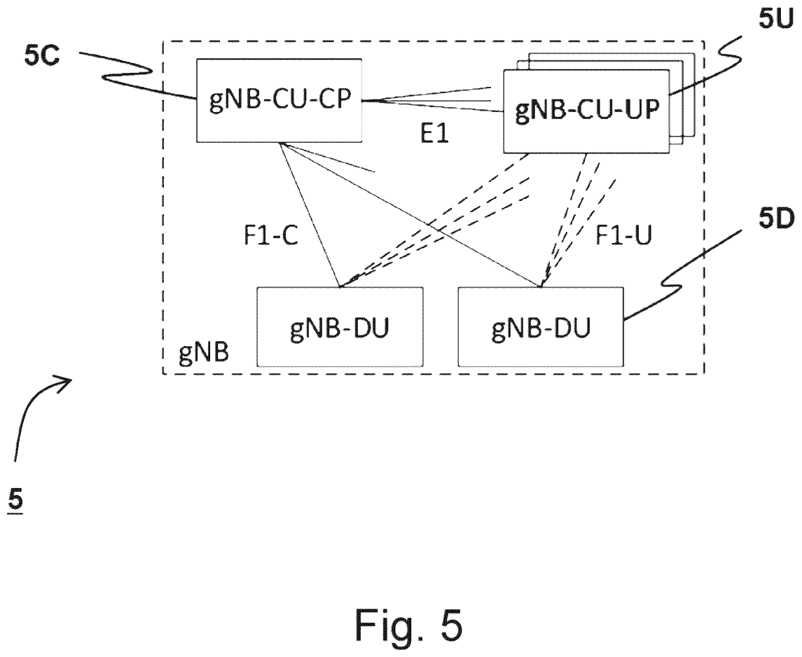

As shown in FIG. 5, when the base station 5 comprises a distributed base station (gNB or en-gNB), the network interface 55 also includes an E1 interface and an F1 interface (F1-C for control plane and F1-U for user plane) to communicate signals between respective functions of the distributed base station. In this case, the software also includes at least one of: a gNB-CU-CP module 5C, a gNB-CU-UP module 5U, and a gNB-DU module 5D. If present, the gNB-CU-CP module 5C hosts the RRC layer and the control plane part of the PDCP layer of the distributed base station (gNB or en-gNB). If present, the gNB-CU-UP module 5U hosts the user plane part of the PDCP and the SDAP layers of the distributed gNB or the user plane part of the PDCP layer of the distributed en-gNB. If present, the gNB-DU module 5D hosts the RLC, MAC, and PHY layers of the distributed base station (gNB or en-gNB).

It will be understood by a person skilled in the art that the central unit (e.g. 5C and/or 5U) may be implemented and physically located with the base station or may be implemented at a remote location, as a single physical element or as a cloud-based or virtualised system. It will also be understood that a single central unit may serve multiple base stations 5.

### Core Network Node

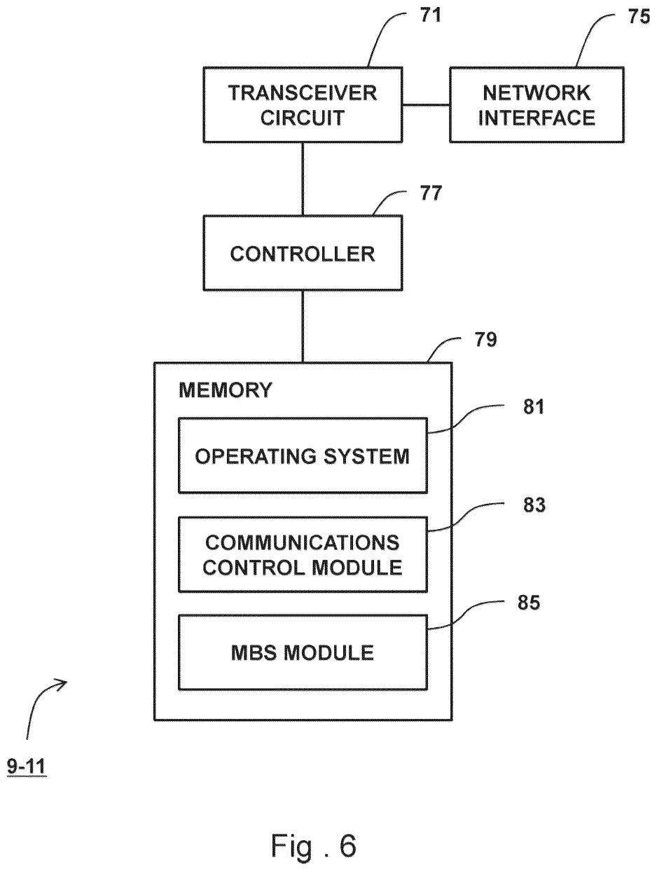

FIG. 6 is a block diagram illustrating the main components of a core network node shown in FIGS. 1 and 2 (e.g. the AMF 9, the UPF 10, or the SMF 11). As shown, the core network node includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the base station 5 or other (R)AN nodes, as appropriate. The network interface 75 typically includes an appropriate base station interface (such as S1/NG-C/NG-U). A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an MBS module 85 (optional).

The communications control module 83 is responsible for handling (generating/sending/receiving) signalling between the core network node and other nodes, such as the UE 3, (R)AN nodes, and other core network nodes.

If present, e.g. in an MB-SMF or MB-UPF, the MBS module 85 is responsible for handling signalling relating to multimedia broadcast services (control signalling and/or MBS traffic). The signalling may comprise signalling relating to the provision of MBS sessions via a shared RAN/shared base station, and signalling for configuring other nodes for providing the MBS session via the shared RAN/shared base station.

### DETAILED DESCRIPTION

The TMGI is the MBS session identifier that uniquely identifies a particular MBS Service. The TMGI has three parts: an MBMS Service ID part; a Mobile Country Code (MCC) part; and a Mobile Network Code (MNC) part. NPL 3, clause 9.3.1.aaa defines the three parts of the TMGI as follows:
1) MBMS Service ID consisting of three octets. MBMS Service ID consists of a 6-digit fixed-length hexadecimal number between 000000 and FFFFFF. MBMS Service ID uniquely identifies an MBMS bearer service within a PLMN. The structure of MBMS Service ID for services for Receive only mode is defined in NPL 4;
2) Mobile Country Code (MCC) consisting of three digits. The MCC identifies uniquely the country of domicile of the Broadcast-Multicast Service Centre (BM-SC), except for the MCC value of 901, which does not identify any country and is assigned globally by the International Telecommunication Union (ITU); and
3) Mobile Network Code (MNC) consisting of two or three digits (depending on the assignment to the PLMN by its national numbering plan administrator). The MNC identifies the PLMN which the BM-SC belongs to, except for the MNC value of 56 when the MCC value is 901, which does not identify any PLMN. For more information on the use of the TMGI, see NPL 5.

NPL 6: defines the parts of the PLMN ID as follows:
1) Mobile Country Code (MCC) consisting of three digits. The MCC identifies uniquely the country of domicile of the mobile subscription; and
2) Mobile Network Code (MNC), consisting of two or three digits for 3GPP network applications (depending on the assignment to the PLMN by its national numbering plan administrator). The MNC identifies the home PLMN of the mobile subscription within its country of domicile, or it identifies together with MCC and Network Identifier (NID) the mobile subscription's Stand-alone Non-Public Network (SNPN). The length of the MNC (two or three digits) depends on the value of the MCC.

The list of PLMNs supported in a cell is indicated in the relevant system information. Specifically, system information block type 1 (SIB 1) includes the list of supported PLMNs in the plmn-IdentityInfoList information element (which is included in the so-called CellAccessRelatedInfo information element of SIB 1).

Thus, the shared base station 5A broadcasts (in the plmn-IdentityInfoList information element for its cell) the PLMN IDs of the three PLMNs that share this base station 5A indicating which UEs 3 are allowed to access the cell of the base station 5A. For sake of completeness, the second base station 5B broadcasts the PLMN ID of the second PLMN only because the RAN that the base station 5B belongs to is not shared. In other words, the plmn-IdentityInfoList information element may have a single entry only.

The following is a description of some exemplary procedures performed by the nodes of the system shown in FIGS. 1 and 2 to support MBS sessions via a shared RAN (including the shared base station 5A).

In this system, the shared base station 5A transmits to the UEs 3 in its cell information identifying the PLMNs associated with a particular MBS session provided in a cell. The UE 3 is allowed to receive the MBS session in a case that the UE's PLMN is one of the PLMNs indicated by the base station 5A (assuming that the UE 3 is allowed to access the cell based on the list of supported PLMNs in SIB 1, as described above, or any other system information block that can be used for RAN sharing and/or MBS purposes).

In one option, the base station 5A transmits a mapping table to the UE 3 the mapping table indicating the identifier (TMGI) associated with the MBS session and the respective PLMNs associated with the MBS session. The mapping table may be transmitted via the MBS Control Channel (MCCH) or via an application layer procedure. An example of the mapping table is shown below.

| | PLMN ID | MBS session ID |
|---|---|---|
| Entry 1 | PLMN 1 (operator 1) | MBS session ID 1 |
| Entry 2 | PLMN 2 (operator 2) | (TMGI 1) |
| Entry 3 | PLMN 3 (operator 3) | |

Although this exemplary table shows the mapping for a single MBS session, the mapping table may include additional entries for other MBS sessions provided in the cell (if any). It will also be appreciated that different MBS sessions may have different associated PLMNs to allow sharing of the base station 5A selectively.

Since the MBS session ID/TMGI identifies the PLMN that the shared base station 5A belongs to, it may not be necessary to include the PLMN ID of the TMGI in one of the entries. In this case the entries of the table represent the additional PLMN IDs associated with the MBS session ID. Thus, a UE 3 can receive a particular MBS session in the cell of the base station 5A if the UE's PLMN ID is included in one of the entries in the PLMN ID column or in the TMGI indicated in the MBS session ID column.

Since different PLMNs may use different MBS session IDs for the same MBS service, the PLMN (core network 7) of each UE 3 is responsible for configuring an appropriate mapping between each MBS service and the corresponding MBS session (MBS session ID) used in the shared RAN. The mapping between MBS services and corresponding MBS sessions may be transmitted via an application layer procedure.

In another option, network sharing for an MBS session may be indicated using a special MBS session identifier (TMGI) associated with network sharing. Specifically, the TMGI may include a PLMN ID value (a combination of an MCC value and an MNC value) that indicates network sharing. For example, the PLMN ID value may be a reserved PLMN ID value dedicated for MBS network sharing. In other words, the responsible body (ITU or 3GPP) may allocate one of the possible PLMN IDs for network sharing. It will be appreciated that it may be sufficient to reserve a specific MNC value (which may be used in combination with a suitable MCC) for the purpose of network sharing for MBS.

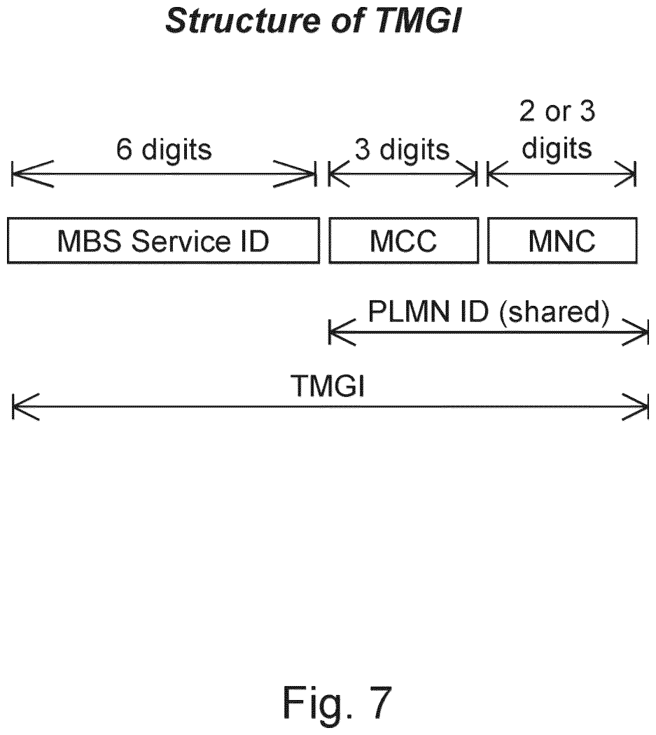

The structure of the TMGI is shown in FIG. 7. As can be seen, in this case the PLMN ID portion of the TMGI (i.e. which is given by the values of the MCC and MNC) is set to a value that indicates network sharing (for the MBS service identified by the MBS service ID portion of the TMGI). Accordingly, a UE 3 can receive a particular MBS session in the cell of the base station 5A if the TMGI for the MBS session (i.e. the PLMN ID/MNC portion) indicates network sharing. In other words, the PLMN ID portion of the TMGI does not need to match the PLMN ID of the UE's home network when such a network sharing specific TMGI or PLMN ID is used.

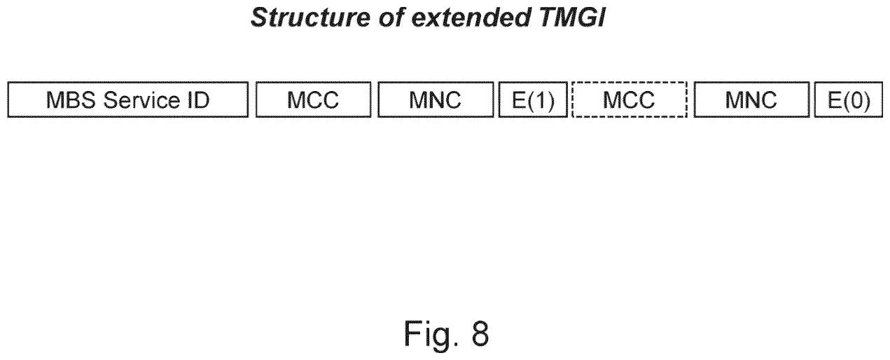

Alternatively, as shown in FIG. 8, the TMGI may be extended to indicate more than one specific PLMNs, by their associated MCC and MNC values. Specifically, after the MBS service ID and the first MCC-MNC pair (first PLMN ID), the TMGI may include an appropriate field (e.g. one bit) indicating whether there are any additional PLMNs associated with that particular MBS service. In this example, when the field (denoted ‘E’ in FIG. 8) is set to an appropriate value (e.g. ‘1’), it indicates that there is another PLMN ID after this field for which the MBS session is allowed. In the example shown in FIG. 8, after the second MCC-MNC pair (second PLMN ID), the extension field is set to a different value (e.g. ‘0’ or vice versa) indicating that there are no additional PLMN IDs in this TMGI (effectively, indicating the end of this particular TMGI). It will be appreciated that any additional PLMN ID may be indicated by its MNC if it has the same MCC. Accordingly, the MCC value is optional after the TMGI extension field.

Configuration of network sharing for MBS In unicast RAN sharing network, the core network 7 of each PLMN connects to the shared RAN independently. No interaction and coordination is needed between PLMNs because MBS is provided via unicast (each PLMN is using its own TMGI).

Each core network 7 has an interface to the shared RAN (e.g. an appropriate NG interface in case of 5G networks). The shared RAN (shared base station 5A) receives appropriate configuration information from each core network 7 and adds a PLMN list to the SIB1 in its cell to inform UEs about the PLMNs supported in the cell. The MBS service provider provides all configuration/admission control information for the MBS content to the shared base station 5.

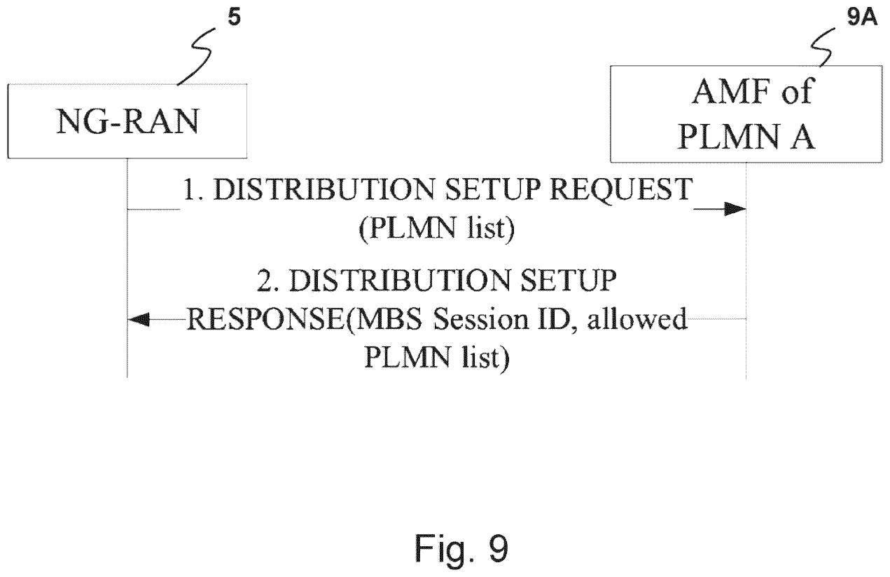

FIG. 9 is a schematic timing (signalling) diagram illustrating an exemplary method for configuring the shared base station 5A for providing MBS sessions to subscribers (UEs) of multiple PLMNs.

In this case, MBS services are provided by the operator of the shared base station 5A. However, different MBS services may be shared by different PLMNs. For example, one MBS session may be shared with the UEs 3 of operator B and another MBS session may be shared with the UEs 3 of operator C (in addition to the UEs of the operator of the shared base station 5A).

Initially, the AMF 9A (which belongs to the MBS service provider's core network 7A) sets up a non-UE associated MBS session for each MBS service, allowing admission of each operator's UEs 3. Then, as shown in step 1 of FIG. 9, the shared base station 5A (denoted NG-RAN) sends, to the AMF 9A, a message for establishing the MBS session in the cell (e.g. a Distribution Setup Request message). The shared base station 5A includes in this message information identifying the PLMNs supported by the shared base station 5A.

The AMF 9A responds to this message by transmitting information identifying those PLMNs (e.g. an ‘allowed PLMN list’ information element and/or the like) for which the MBS session is allowed in the cell of the shared base station 5A. In this example, the AMF transmits the allowed PLMN list in an appropriately formatted Distribution Setup Response message, which also includes an identifier of the MBS session to which the list relates. It will be appreciated that the process may be executed (repeated) for each MBS session, although a single request-response procedure may be used for providing respective allowed PLMN lists for multiple MBS sessions (together with the corresponding MBS session IDs).

After the base station 5A knows which PLMNs are allowed for a particular MBS session, the base station 5A transmits to the UEs 3 information identifying the PLMNs associated with that MBS session provided by the shared base station 5A (e.g. a mapping table or a PLMN ID/TMGI indicating network sharing).

### Configuration of Neighbouring Base Stations

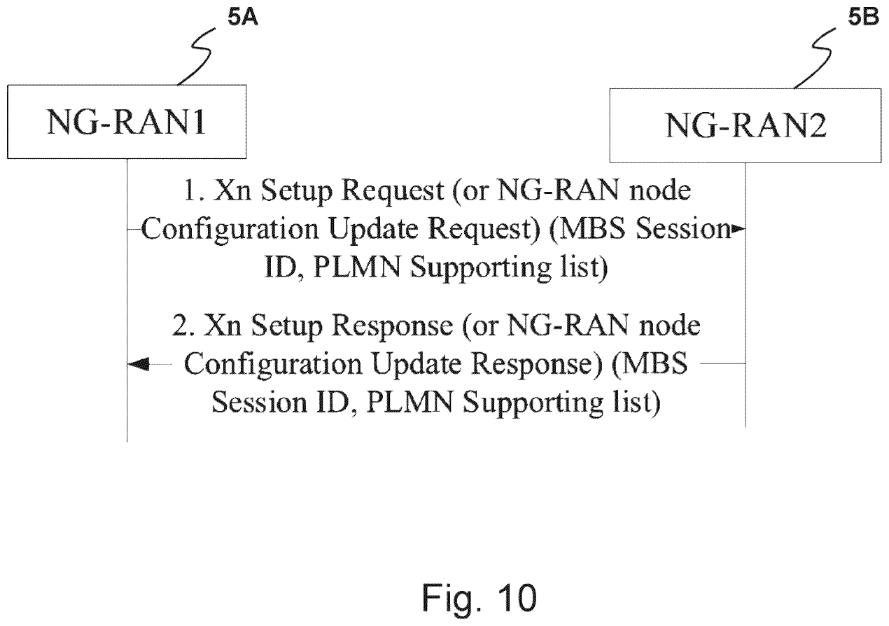

FIG. 10 is a schematic timing (signalling) diagram illustrating an exemplary method for exchanging information between neighbouring base stations 5 regarding the supported PLMNs for each MBS session.

This procedure may be particularly useful for facilitating UE mobility between different cells in dependence on the PLMNs supported in each cell (e.g. to help idle mode UEs select an appropriate cell for receiving an MBS session). In case of a handover of a UE 3, the source base station 5 may need to know whether the neighbour cell supports a particular MBS service for the UE's PLMN.

Neighbouring base stations 5 are configured to exchange information indicating which PLMNs are supported for each MBS session (e.g. a supported PLMN list per MBS session). This information may be exchanged using the base station to base station (e.g. Xn) interface between the base stations 5.

As shown in step 1 of FIG. 10, the procedure may be initiated by one of the base stations (in this example the shared base station 5A) by generating and sending an appropriately formatted message for managing a connection between the base station 5A and the neighbour base station 5B. The message may be a message for setting up a connection between the base stations 5A and 5B (e.g. an Xn setup request) or a message for updating a configuration relating to the base stations 5A and 5B (e.g. an NG-RAN node configuration update request). The message includes, for each MBS session supported by the base station 5A: information identifying the given MBS session (e.g. MBS session ID/TMGI); and information identifying the PLMN (at least one) supported in the cell of the base station 5A (for the given MBS session).

In the corresponding response, shown in step 2, the neighbour base station 5B indicates its MBS sessions and the supported PLMNs per MBS session. The response may be, for example, an Xn setup response or an NG-RAN node configuration update response, and it may include, for each MBS session supported by the base station 5B: information identifying the given MBS session; and information identifying the PLMN (at least one) supported in the cell of the base station 5B. It will be appreciated that each base station 5 may be configured to provide this information to a neighbour base station regardless whether the corresponding request or response message includes the neighbour base station's MBS information.

Once the base stations 5 obtain the information identifying the MBS sessions and PLMNs supported by their neighbour, they broadcast this information in their cell (in system information) so that UEs 3 in the cell can perform mobility procedures accordingly. In particular, each base station 5 may broadcast for its neighbour cell the following information: which MBS session is supported for which PLMN, using which frequency.

### MBS Container

The following is a description of some exemplary ways in which the applicable MBS configuration may be provided to a UE 3 to receive an MBS session via a shared base station 5A (shared RAN). The MBS configuration is referred to as an ‘MBS container’ using the currently adopted 3GPP terminology.

Each UE 3 needs to be configured with an appropriate MBS container in order to be able to receive an MBS session. The MBS container is sent in the so-called PDU Session Modification Command from the AMF/SMF 9/11 to the UE 3, which includes the relevant configuration in the ‘Requested MBS container’ field.

As discussed above, the supported PLMN list is indicated via the SIB1. If the PLMN ID of the UE's home PLMN is included in the SIB1 (in plmn-IdentityInfoList) for a network, then the UE 3 performs an initial access to that network (which may be referred to as the serving PLMN). Network sharing for MBS aims to save radio resources, as more than one operator can provide the same multicast MBS service via a shared RAN. However, it will be appreciated that the UE 3 may be allowed to access the network only for the reception of the MBS service, no other service. Thus, an MBS UE may have an MBS session (via point-to-multipoint) in the shared RAN from the shared PLMN, but any other dedicated service is provided only in its own PLMN. The configuration for receiving an MBS session provided by any other PLMN is configured by the UE's home PLMN.

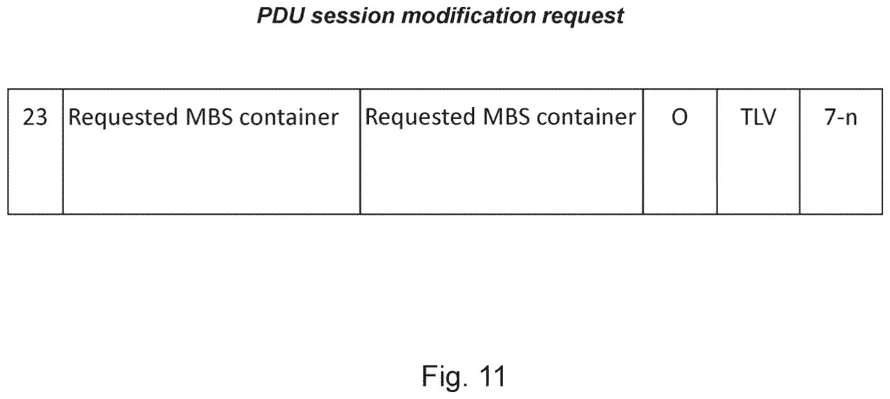

FIG. 11 illustrates an exemplary field of a message (PDU session modification request) that may be used by a UE 3 to obtain the applicable MBS configuration. NPL 7 describes that the PDU session modification request message is sent by the UE 3 to the SMF 11 to request a modification of a PDU session. One of the fields of this message is the so-called Requested MBS container field which may be used by the UE 3 to request an MBS container for a given MBS service.

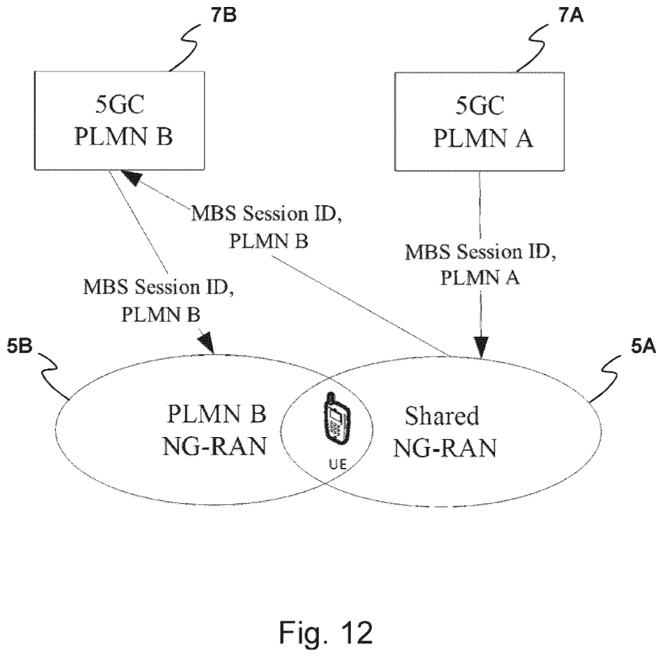

In the following, it will be assumed that the UE 3 belongs to PLMN B (home PLMN), and the MBS service (MBS session) is provided by PLMN A (serving PLMN) in the cell of the shared base station 5A. FIG. 12 illustrates schematically the relationship between the shared RAN (PLMN A) and the UE's home network (PLMN B), and the flow of information.

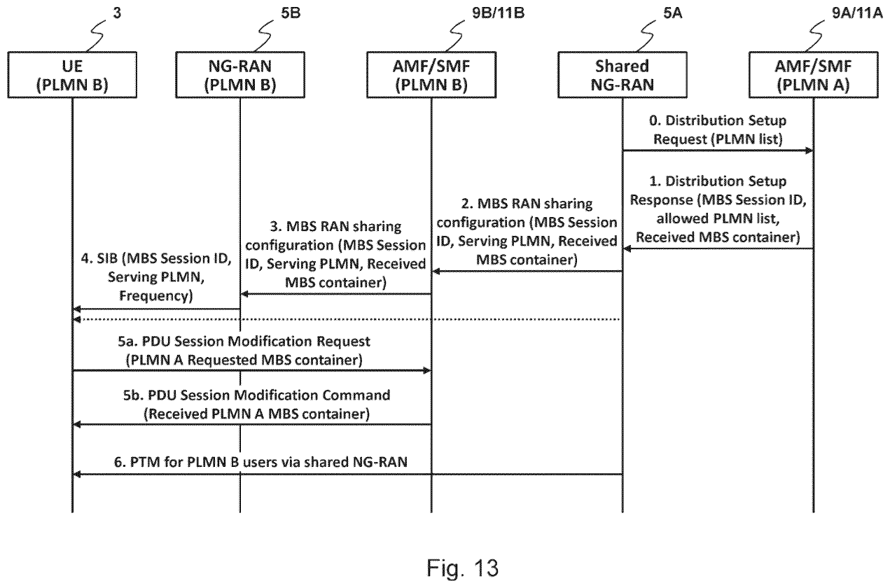

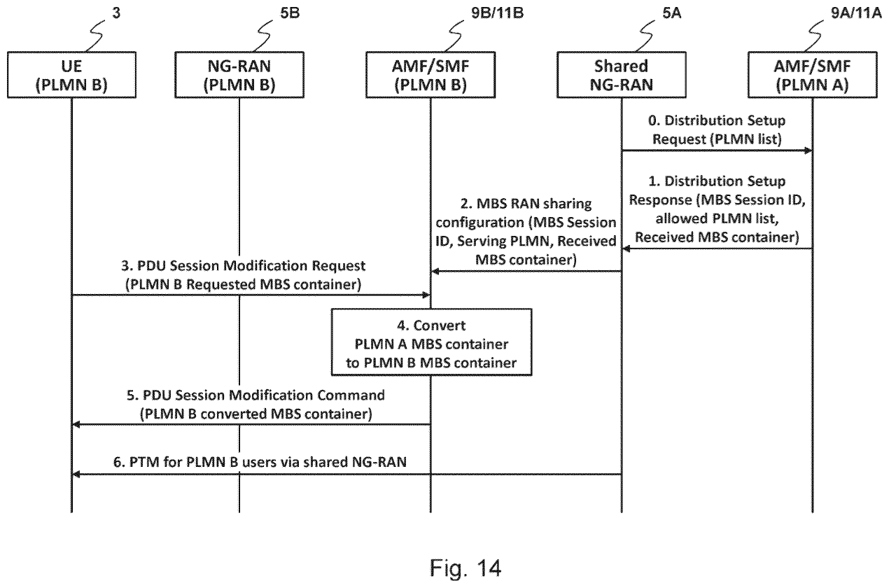

FIGS. 13 and 14 are schematic timing (signalling) diagrams illustrating some exemplary ways in which an appropriate MBS container may be provided to a UE 3 for receiving an MBS session via the shared base station 5A (e.g. using a point-to-multipoint bearer).

In the first option, illustrated in FIG. 13, the system information of the shared RAN configures the MBS container.

In more detail, the procedure begins in step 0. in which the shared RAN (base station 5A) informs the core network 7A about the supported PLMNs. In this example, the base station 5A generates and sends, to the AMF 9A, a message for establishing the MBS session (e.g. a Distribution Setup Request message and/or the like), which includes information identifying the PLMNs supported by the shared base station 5A. The AMF 9A invokes the services of the SMF 11A for setting up the MBS session (not shown in FIG. 13).

Step 1: The core network 7A establishes the MBS session for the shared RAN, and indicates that PLMN B is supported for RAN sharing for this particular MBS session ID.

The core network 7A also provides the applicable MBS Non-Access Stratum (NAS) configuration. In this example, the core network 7A transmits a Distribution Setup Response message (and/or the like), which includes the NAS configuration in the so-called Received MBS container field, and identifies which PLMNs are allowed for that particular MBS session (which may include all the PLMNs supported by the shared RAN/shared base station 5A or a subset thereof).

Step 2: Once the base station 5A knows which PLMNs are allowed for the MBS session, the base station 5A notifies PLMN B about the support of this particular MBS session in PLMN A, along with the associated MBS session ID and configuration (‘Received MBS container’). In this example, the base station 5A notifies PLMN B by transmitting an MBS RAN Sharing Configuration message (and/or the like) to the core network 7B of PLMN B.

Step 3: The core network 7B of PLMN B configures the RAN of PLMN B to support the MBS session ID by PLMN A, by forwarding the RAN Sharing Configuration and the Received MBS container to the base stations of PLMN B (in this example, base station 5B).

Step 4: The RAN (base station 5B) of home PLMN B broadcasts information indicating that the MBS session ID is supported for subscribers of PLMN B and the MBS session will be provided via PLMN A. Specifically, the base station 5B broadcasts, in system information, the MBS session ID (TMGI) associated with the MBS service, information identifying the serving PLMN (PLMN ID) and the frequency associated with the MBS service.

As generally illustrated in steps 5a and 5b, if the UE 3 (of PLMN B) is interested in receiving this MBS service, it obtains the necessary configuration (MBS container) from its home network. Accordingly, the UE 3 registers to PLMN B (home PLMN), and transmits an appropriately formatted PDU Session Modification Request to the AMF 9B requesting the MBS container for the MBS session provided via PLMN A. It will be appreciated that although the MBS session is provided via the shared RAN (PLMN A), since the UE 3 is not a subscriber of that network it will need to obtain the necessary configuration from its home PLMN (PLMN B). However, the Requested MBS container field of the PDU Session Modification Request may refer to a PLMN A MBS container, as shown in step 5a.

In response to the UE's request, the AMF 9B of the home PLMN generates and transmits an appropriately formatted PDU Session Modification Command including the Received MBS container of PLMN A.

If a point-to-multipoint (multicast) bearer is used for the MBS service in PLMN A, the UE 3 (and any other UE allowed to use the service) is able to receive the MBS session using the point-to-multipoint (PTM) bearer, as generally shown in step 6.

In the second option, illustrated in FIG. 14, the UE requests the MBS container from the serving AMF 9B (of the home PLMN), and the serving AMF 9B converts the MBS container provided by the serving PLMN (PLMN A) to a shared PLMN MBS container that can be used by the UE 3 to receive the MBS session in the cell of the shared base station 5A. In this case it is not necessary to notify the UE 3 in advance (via system information) that the MBS session is provided via a different PLMN.

Steps 0. to 2. of FIG. 14 are the same as the corresponding steps of FIG. 13 described above. In step 3, the UE 3 sends an appropriately formatted PDU Session Modification Request with PLMN B Requested MBS container. Although this step is similar to step 5a of FIG. 13, in this case the UE 3 may not be aware that the MBS session is provided by the shared base station 5A (PLMN A). Thus, in step 4, the AMF 9B of PLMN B converts the received PLMN A MBS container to an appropriate PLMN B MBS container. The MBS container includes, amongst others, the MBS session ID (TMGI) associated with the MBS service provided in PLMN A, information identifying the serving PLMN (PLMN ID of PLMN A), and the frequency associated with the MBS service (by the shared base station 5A). In step 5, the AMF 9B of PLMN B generates and transmits, to the UE 3, an appropriately formatted PDU Session Modification Command including the converted MBS container (PLMN B MBS container). Using the received MBS container, the UE 3 can receive the MBS session via the shared RAN (step 6).

It will be appreciated that the procedures shown in FIGS. 13 and 14 may be combined with the other procedures described above (e.g. mapping table, extended/network sharing TMGI, MBS/mobility related information exchange between neighbouring base stations).

Beneficially, UEs from different PLMNs are able to obtain appropriate information to select and use a shared base station for receiving MBS sessions, and they may also be able to use point-to-multipoint bearers for the MBS session (if applicable).

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

The above description refers to MBS for simplicity. However, MBS functionality may also be referred to as Multimedia Broadcast/Multicast Services (MBMS) functionality or similar.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 8 and NPL 9 define the following nodes, amongst others:
gNB: node providing NR user plane and control plane protocol terminations towards the UE, and connected via the NG interface to the 5G core network (5GC).
ng-eNB: node providing E-UTRA user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

It will be appreciated that the above example embodiments may be applied to 5G New Radio and LTE systems (E-UTRAN), and any future generation systems. A base station that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

In the above description, the UE, the access network node, and the data network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node, and the data network node as a signal over a computer network, or on a recording medium. Further, the functionality performed by part or all of this software may be performed using one or more dedicated hardware circuits. However, the use of software modules is preferred as it facilitates the updating of the UE, the access network node, and the data network node in order to update their functionalities.

The above example embodiments are also applicable to ‘non-mobile’ or generally stationary user equipment.

The information may include a mapping table indicating an identifier associated with the MBS session and the plurality of PLMNs, and the receiving of the MBS session may be performed in a case where the first PLMN is included in the plurality of PLMNs. For example, the identifier may include a Temporary Mobile Group Identity (TMGI) identifying one of the plurality of PLMNs (e.g. a PLMN other than the first PLMN).

The receiving of the information may be performed via an MBS Control Channel (MCCH) or via an application layer procedure.

The information may include a PLMN identifier reserved for network sharing, in which case the receiving of the MBS session may be performed in a case where the information includes the specific PLMN identifier. The PLMN identifier may include a Mobile Network Code (MNC) reserved to indicate the network sharing.

The information may include an MBS session identifier associated with the MBS session, including an MBS service identifier and information identifying the plurality of PLMNs, and the receiving of the MBS session may be performed in a case where the information identifying the plurality of PLMNs indicates the first PLMN.

The MBS session identifier may be a Temporary Mobile Group Identity (TMGI). In this case, the TMGI may include a first PLMN identifier and at least one additional PLMN identifier, separated by at least one respective indicator field indicating the presence of the at least one additional PLMN identifier.

The shared cell may be operated by a PLMN other than the first PLMN.

The method performed by the UE may further comprise: receiving, from the first PLMN, information identifying the second PLMN as the PLMN that provides the MBS session and information identifying a frequency for the MBS session; and requesting the MBS container in a procedure for modifying a Protocol Data Unit (PDU) session for the MBS session.

The information identifying the second PLMN may be included in a system information block type 1 (SIB 1).

The MBS container may be received from a core network function of the first PLMN, in a procedure for modifying a Protocol Data Unit (PDU) session for the MBS session, and the MBS container may include information identifying the second PLMN as the PLMN that provides the MBS session and information identifying a frequency for the MBS session. The MBS container may be used to configure the UE for receiving the MBS session via a second PLMN using a point-to-multipoint bearer.

The method performed by the UE may further comprise: receiving, from the second PLMN, information identifying a plurality of PLMNs associated with the MBS session in a cell of the second PLMN; and receiving the MBS session in the cell in a case that the first PLMN is included in the plurality of PLMNs.

The method performed by the access network node for the shared radio access network may further comprise receiving, from a core network function, in a procedure for setting up the MBS session in the cell, the information identifying the plurality of PLMNs.

The information identifying at least one PLMNs among the plurality of PLMNs, for which the MBS session is allowed in the cell, may be received by the shared access network node in a procedure for establishing the MBS session at the access network node.

The method performed by the shared access network node may further comprise: receiving, from the core network function, configuration information for providing the MBS session in the cell; and transmitting the configuration information to a further core network function associated with one of the at least one PLMN, for configuring a user equipment (UE) associated with the one of the at least one PLMN to receive the MBS session in the cell.

The method may further comprise: transmitting, to the core network function, before receiving the information identifying the at least one PLMN for which the MBS session is allowed in the cell, a message for establishing the MBS session in the cell, the message including information identifying the plurality of the PLMNs.

The receiving of the first and second information may comprise: receiving the first and second information in a procedure for managing a connection between the access network node and the other access network node.

The first and second information may be received in a response for setting up a connection between the access network node and the other access network node or in a response for updating a configuration for the other access network node.

The method performed by the access network node may further comprise: selecting the cell as a handover target for a user equipment (UE) based on the first and second information.

The method performed by the access network node operating the shared cell may comprise transmitting in a request for setting up a connection between the access network node and the other access network node or in a request for updating a configuration for the other access network node.

The information identifying the second PLMN may be included in system information, for example system information block type 1 (SIB 1) or any other system information block used for RAN sharing and/or MBS purposes.

The method performed by the core network function may further comprise configuring a user equipment (UE) associated with the first PLMN to receive the MBS session in the second PLMN based on the configuration information. In this case, the configuring the UE may include forwarding the MBS container towards the UE upon request. Alternatively, the method performed by the core network function may further comprise: converting the MBS container to an MBS container for the first PLMN; and forwarding the converted MBS container towards the UE upon request.

The core network function may include at least one of a function for access and mobility management and a function for session management.

Various other modifications will be apparent to those skilled in the art and will not be described in further detail here.

The whole or part of the exemplary embodiments disclosed above can be described as, but not limited to, the following supplementary notes.

### (Supplementary Note 1)

A method performed by a user equipment (UE) associated with a first Public Land Mobile Network (PLMN), the method comprising:
receiving information identifying a plurality of PLMNs which correspond to a shared radio access network and which are associated with a Multicast and Broadcast Services (MBS) session to be provided in a cell operated by the shared radio access network; and
receiving the MBS session in the cell based on the information.

### (Supplementary Note 2)

The method according to Supplementary Note 1, wherein
the information includes a mapping table indicating an identifier associated with the MBS session and the plurality of PLMNs, and
the receiving of the MBS session is performed in a case where the first PLMN is included in the plurality of PLMNs.

### (Supplementary Note 3)

The method according to Supplementary Note 2, wherein the identifier includes a Temporary Mobile Group Identity (TMGI) identifying one of the plurality of PLMNs other than the first PLMN.

### (Supplementary Note 4)

The method according to any of Supplementary Notes 1 to 3, wherein the receiving of the information is performed via an MBS Control Channel (MCCH) or via an application layer procedure.

### (Supplementary Note 5)

The method according to Supplementary Note 1, wherein the information includes a PLMN identifier reserved for network sharing, and
the receiving of the MBS session is performed in a case where the information includes the specific PLMN identifier.

### (Supplementary Note 6)

The method according to Supplementary Note 5, wherein the PLMN identifier includes a Mobile Network Code (MNC) reserved to indicate the network sharing.

### (Supplementary Note 7)

The method according to Supplementary Note 1, wherein
the information includes an MBS session identifier associated with the MBS session, including an MBS service identifier and information identifying the plurality of PLMNs, and
the receiving of the MBS session is performed in a case where the information identifying the plurality of PLMNs indicates the first PLMN.

### (Supplementary Note 8)

The method according to Supplementary Note 7, wherein the MBS session identifier is a Temporary Mobile Group Identity (TMGI).

### (Supplementary Note 9)

The method according to Supplementary Note 8, wherein the TMGI includes a first PLMN identifier and at least one additional PLMN identifier, separated by at least one respective indicator field indicating the presence of the at least one additional PLMN identifier.

### (Supplementary Note 10)

The method according to any of Supplementary Notes 1 to 9, wherein the cell is operated by a PLMN other than the first PLMN.

### (Supplementary Note 11)

A method performed by a user equipment (UE) associated with a first Public Land Mobile Network (PLMN), the method comprising:
receiving, from the first PLMN, a Multicast and Broadcast Services (MBS) container including configuration information for receiving an MBS session via a second PLMN.

### (Supplementary Note 12)

The method according to Supplementary Note 11, further comprising:
receiving, from the first PLMN, information identifying the second PLMN as the PLMN that provides the MBS session and information identifying a frequency for the MBS session; and
requesting the MBS container in a procedure for modifying a Protocol Data Unit (PDU) session for the MBS session.

### (Supplementary Note 13)

The method according to Supplementary Note 12, wherein the information identifying the second PLMN is included in a system information block.

### (Supplementary Note 14)

The method according to Supplementary Note 11, wherein
the receiving the MBS container includes receiving from a core network function of the first PLMN, in a procedure for modifying a Protocol Data Unit (PDU) session for the MBS session, wherein
the MBS container includes information identifying the second PLMN as the PLMN that provides the MBS session and information identifying a frequency for the MBS session.

### (Supplementary Note 15)

The method according to any of Supplementary Notes 11 to 14, wherein the MBS container configures the UE for receiving the MBS session via a second PLMN using a point-to-multipoint bearer.

### (Supplementary Note 16)

The method according to any of Supplementary Notes 11 to 15, further comprising:
receiving, from the second PLMN, information identifying a plurality of PLMNs associated with the MBS session in a cell of the second PLMN; and
receiving the MBS session in the cell in a case that the first PLMN is included in the plurality of PLMNs.

### (Supplementary Note 17)

A method performed by an access network node for a radio access network shared among a plurality of Public Land Mobile Networks (PLMNs), the method comprising:
transmitting, in a cell of the shared radio access network, information identifying the plurality of PLMNs associated with a Multicast and Broadcast Services (MBS) session to be provided in the cell; and
transmitting, in the cell, the MBS session based on the information.

### (Supplementary Note 18)

The method according to Supplementary Note 17, further comprising: receiving, from a core network function, in a procedure for setting up the MBS session in the cell, the information identifying the plurality of PLMNs.

### (Supplementary Note 19)

A method performed by an access network node for a radio access network shared among a plurality of Public Land Mobile Networks (PLMNs), for providing a Multicast and Broadcast Services (MBS) session in a cell, the method comprising:
receiving, from a core network function of a first PLMN of the plurality of the PLMNs, information identifying at least one PLMNs among the plurality of PLMNs, for which the MBS session is allowed in the cell.

### (Supplementary Note 20)

The method according to Supplementary Note 19, wherein the receiving is performed in a procedure for establishing the MBS session at the access network node.

### (Supplementary Note 21)

The method according to Supplementary Note 19 or 20, further comprising:
receiving, from the core network function, configuration information for providing the MBS session in the cell; and
transmitting the configuration information to a further core network function associated with one of the at least one PLMN, for configuring a user equipment (UE) associated with the one of the at least one PLMN to receive the MBS session in the cell.

### (Supplementary Note 22)

The method according to any of Supplementary Notes 19 to 21, further comprising:
transmitting, to the core network function, before receiving the information identifying the at least one PLMN for which the MBS session is allowed in the cell, a message for establishing the MBS session in the cell, the message including information identifying the plurality of the PLMNs.

### (Supplementary Note 23)

A method performed by an access network node for providing Multicast and Broadcast Services (MBS), the method comprising:
receiving, from another access network node which operates a cell of a radio access network shared among a plurality of Public Land Mobile Networks (PLMNs), first information identifying at least one MBS session supported in the cell and second information identifying, for each particular MBS session of the at least one MBS session, at least one PLMN which supports the particular MBS session.

### (Supplementary Note 24)

The method according to Supplementary Note 23, wherein the receiving the first and second information comprises:
receiving the first and second information in a procedure for managing a connection between the access network node and the other access network node.

### (Supplementary Note 25)

The method according to Supplementary Note 23 or 24, wherein the receiving is performed in a response for setting up a connection between the access network node and the other access network node or in a response for updating a configuration for the other access network node.

### (Supplementary Note 26)

The method according to any of Supplementary Notes 23 to 25, further comprising:
selecting the cell as a handover target for a user equipment (UE) based on the first and second information.

### (Supplementary Note 27)

A method performed by an access network node operating a cell shared among a plurality of Public Land Mobile Networks (PLMNs), the method comprising:
transmitting, to another access network node operating a neighbour cell, first information identifying at least one Multicast and Broadcast Services (MBS) session supported by the access network node and second information identifying, for each particular MBS session, at least one PLMN which supports the particular MBS session.

### (Supplementary Note 28)

The method according to Supplementary Note 27, wherein the transmitting is performed in a request for setting up a connection between the access network node and the other access network node or in a request for updating a configuration for the other access network node.

### (Supplementary Note 29)

A method performed by an access network node for a radio access network shared among a plurality of Public Land Mobile Networks (PLMNs), the method comprising:
transmitting, to a core network function, information identifying the plurality of PLMNs; and
receiving, from the core network function, an MBS container including configuration information for providing a Multicast and Broadcast Services (MBS) session for at least one PLMN among the plurality of PLMNs and information identifying the at least one PLMN for which the MBS session is allowed via the shared access network.

### (Supplementary Note 30)

A method performed by an access network node associated with a first Public Land Mobile Network (PLMN), the method comprising:
transmitting, to a user equipment (UE), information identifying a second PLMN as a PLMN that provides a Multicast and Broadcast Services (MBS) session and information identifying a frequency for the MBS session.

### (Supplementary Note 31)

The method according to Supplementary Note 30, wherein the information identifying the second PLMN is included in a system information block.

### (Supplementary Note 32)

A method performed by a core network function, the method comprising:
receiving, from an access network node for a radio access network shared among a plurality of Public Land Mobile Networks (PLMNs), information identifying the plurality of PLMNs; and
transmitting, to the access network node, an MBS container including configuration information for providing a Multicast and broadcast Services (MBS) session for at least one PLMNs among the plurality of PLMNs and information identifying the at least one PLMN for which the MBS session is allowed via the shared access network.

### (Supplementary Note 33)

A method performed by core network function associated with a first Public Land Mobile Network (PLMN), the method comprising:
receiving, from a second PLMN, a Multicast and Broadcast Services (MBS) container for the second PLMN, the MBS container including configuration information for providing an MBS session in the second PLMN.

### (Supplementary Note 34)

The method according to Supplementary Note 33, further comprising: configuring a user equipment (UE) associated with the first PLMN to receive the MBS session in the second PLMN based on the configuration information.

### (Supplementary Note 35)

The method according to Supplementary Note 34, wherein the configuring the UE includes forwarding the MBS container towards the UE upon request.

### (Supplementary Note 36)

The method according to Supplementary Note 34, further comprising: converting the MBS container to an MBS container for the first PLMN; and forwarding the converted MBS container towards the UE upon request.

### (Supplementary Note 37)

The method according to any of Supplementary Notes 14, 18 to 22, 29, and 32 to 36 wherein the core network function includes at least one of a function for access and mobility management and a function for session management.

### (Supplementary Note 38)

A user equipment (UE) associated with a first Public Land Mobile Network (PLMN), the UE comprising:
means for receiving information identifying a plurality of PLMNs which correspond to a shared radio access network and which are associated with a Multicast and Broadcast Services (MBS) session to be provided in a cell operated by the shared radio access network; and
means for receiving the MBS session in the cell based on the information.

### (Supplementary Note 39)

A user equipment (UE) associated with a first Public Land Mobile Network (PLMN), the UE comprising:
means for receiving, from the first PLMN, a Multicast and Broadcast Services (MBS) container including configuration information for receiving an MBS session via a second PLMN.

### (Supplementary Note 40)

An access network node for a radio access network shared among a plurality of Public Land Mobile Networks (PLMNs), the access network node comprising:
means for transmitting, in a cell of the shared radio access network, information identifying the plurality of PLMNs associated with a Multicast and Broadcast Services (MBS) session to be provided in the cell; and
means for transmitting, in the cell, the MBS session based on the information.

### (Supplementary Note 41)

An access network node for a radio access network shared among a plurality of Public Land Mobile Networks (PLMNs), for providing a Multicast and Broadcast Services (MBS) session in a cell, the access network node comprising:
means for receiving, from a core network function of a first PLMN of the plurality of the PLMNs, information identifying at least one PLMNs among the plurality of PLMNs, for which the MBS session is allowed in the cell.

### (Supplementary Note 42)

An access network node for providing Multicast and Broadcast Services (MBS), the access network node comprising:
means for receiving, from another access network node which operates a cell of a radio access network shared among a plurality of Public Land Mobile Networks (PLMNs), first information identifying at least one MBS session supported in the cell and second information identifying, for each particular MBS session of the at least one MBS session, at least one PLMN which supports the particular MBS session.

### (Supplementary Note 43)

An access network node operating a cell shared among a plurality of Public Land Mobile Networks (PLMNs), the access network node comprising:
means for transmitting, to another access network node operating a neighbour cell, first information identifying at least one Multicast and Broadcast Services (MBS) session supported by the access network node and second information identifying, for each particular MBS session, at least one PLMN which supports the particular MBS session.

### (Supplementary Note 44)

An access network node for a radio access network shared among a plurality of Public Land Mobile Networks (PLMNs), the access network node comprising:
means for transmitting, to a core network function, information identifying the plurality of PLMNs; and
means for receiving, from the core network function, an MBS container including configuration information for providing a Multicast and Broadcast Services (MBS) session for at least one PLMN among the plurality of PLMNs and information identifying the at least one PLMN for which the MBS session is allowed via the shared access network.

### (Supplementary Note 45)

An access network node associated with a first Public Land Mobile Network (PLMN), the access network node comprising:
means for transmitting, to a user equipment (UE), information identifying a second PLMN as a PLMN that provides a Multicast and Broadcast Services (MBS) session and information identifying a frequency for the MBS session.

### (Supplementary Note 46)

A core network function comprising:
means for receiving, from an access network node for a radio access network shared among a plurality of Public Land Mobile Networks (PLMNs), information identifying the plurality of PLMNs; and
means for transmitting, to the access network node, an MBS container including configuration information for providing a Multicast and broadcast Services (MBS) session for at least one PLMNs among the plurality of PLMNs and information identifying the at least one PLMN for which the MBS session is allowed via the shared access network.

### (Supplementary Note 47)

A core network function associated with a first Public Land Mobile Network (PLMN), the core network function comprising:
means for receiving, from a second PLMN, a Multicast and Broadcast Services (MBS) container for the second PLMN, the MBS container including configuration information for providing an MBS session in the second PLMN.

This application is based upon and claims the benefit of priority from Great Britain Patent Application No. 2207528.7, filed on May 23, 2022, the disclosure of which is incorporated herein in its entirety by reference.

### REFERENCE SIGNS LIST

1 mobile (cellular or wireless) telecommunication system
3 mobile device
5 base station
7 core network
9 AMF
10 UPF
11 SMF
31 transceiver circuit
33 antenna
35 user interface
36 USIM
39 memory
41 operating system
43 communications control module
45 MBS module
51 transceiver circuit
53 antenna
55 network interface
57 controller
59 memory
61 operating system
63 communications control module
5C gNB-CU-CP module
5U gNB-CU-UP module
5D gNB-DU module
71 transceiver circuit
75 network interface
77 controller
79 memory
81 operating system
83 communications control module
85 MBS module

What is claimed is:

1-47. (canceled)

48. A method performed by a user equipment (UE) associated with a first Public Land Mobile Network (PLMN), the method comprising:
receiving, via a Multicast and Broadcast Services (MBS) Control Channel (MCCH) or via an application layer procedure, information indicating a mapping between a plurality of PLMNs and a MBS session to be provided in a cell operated by a shared radio access network; and
receiving data for the MBS session in the cell based on the information.

49. The method according to claim 48, wherein
the receiving the data is performed in a case where the first PLMN is included in the plurality of PLMNs.

50. The method according to claim 48, wherein
the information includes an identifier including a Temporary Mobile Group Identity (TMGI) indicating one of the plurality of PLMNs other than the first PLMN.

51. The method according to claim 48, wherein
the information includes a specific PLMN identifier reserved for network sharing, and
the receiving the data is performed in a case where the information includes the specific PLMN identifier.

52. The method according to claim 51, wherein
the specific PLMN identifier includes a Mobile Network Code (MNC) reserved for the network sharing.

53. The method according to claim 48, wherein
the information includes an MBS session identifier corresponding to the MBS session, including an MBS service identifier and information indicating the plurality of PLMNs, and
the receiving the data is performed in a case where the information indicating the plurality of PLMNs indicates the first PLMN.

54. The method according to claim 53, wherein
the MBS session identifier includes a Temporary Mobile Group Identity (TMGI).

55. The method according to claim 54, wherein
the TMGI includes a first PLMN identifier and at least one additional PLMN identifier, separated by at least one respective indicator field indicating the presence of the at least one additional PLMN identifier.

56. The method according to claim 48, wherein
the cell is operated by a PLMN other than the first PLMN.

57. The method according to claim 48, further comprising:
receiving, from the first PLMN, a MBS container including configuration information for receiving an MBS session via a second PLMN corresponding to the shared radio access network.

58. The method according to claim 57, further comprising:
receiving, from the first PLMN, information indicating the second PLMN as the PLMN that provides the MBS session and information indicating a frequency for the MBS session; and
requesting the MBS container in a procedure for modifying a Protocol Data Unit (PDU) session for the MBS session.

59. The method according to claim 58, wherein the information indicating the second PLMN is included in a system information block.

60. The method according to claim 57, wherein
the receiving the MBS container includes receiving from a core network node of the first PLMN, in a procedure for modifying a Protocol Data Unit (PDU) session for the MBS session, wherein
the MBS container includes information indicating the second PLMN as the PLMN that provides the MBS session and information indicating a frequency for the MBS session.

61. The method according to claim 57, wherein
the MBS container configures the UE for receiving the MBS session via a second PLMN using a point-to-multipoint bearer.

62. The method according to claim 57, further comprising:
receiving, from the second PLMN, information indicating a plurality of PLMNs corresponding to the MBS session in a cell of the second PLMN; and
receiving the MBS session in the cell in a case that the first PLMN is included in the plurality of PLMNs.

63. A method performed by an access network node for a radio access network shared among a plurality of Public Land Mobile Networks (PLMNs), the method comprising:
transmitting, in a cell of the shared radio access network, via a Multicast and Broadcast Services (MBS) Control Channel (MCCH) or via an application layer procedure, information indicating a mapping between the plurality of PLMNs and a MBS session to be provided in the cell; and
transmitting, in the cell, data for the MBS session based on the information.

64. A user equipment (UE) associated with a first Public Land Mobile Network (PLMN), the UE comprising:
at least one memory storing instructions; and
at least one processor configured to process the instructions to:
receive, via a Multicast and Broadcast Services (MBS) Control Channel (MCCH) or via an application layer procedure, information indicating a mapping between a plurality of PLMNs and a MBS session to be provided in a cell operated by a shared radio access network; and
receive data for the MBS session in the cell based on the information.

65. An access network node for a radio access network shared among a plurality of Public Land Mobile Networks (PLMNs), the access network node comprising:
at least one memory storing instructions; and
at least one processor configured to process the instructions to:
transmit, in a cell of the shared radio access network, via a Multicast and Broadcast Services (MBS) Control Channel (MCCH) or via an application layer procedure, information indicating a mapping between the plurality of PLMNs and a Multicast and Broadcast Services (MBS) session to be provided in the cell; and
transmit, in the cell, data for the MBS session based on the information.
